(19) United States
(12) Patent Application Publication
(10) Pub. No.: US 2007/0228955 A1
(43) Pub. Date: Oct. 4, 2007

(54) PLASMA DISPLAY PANEL AND METHOD FOR MANUFACTURING THE SAME

(75) Inventor: Eun A. Moon, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/685,809

(22) Filed: Mar. 14, 2007

(30) Foreign Application Priority Data
Mar. 14, 2006 (KR) 10-2006-0023670
Mar. 14, 2006 (KR) 10-2006-0023671
Mar. 14, 2006 (KR) 10-2006-0023698
Mar. 14, 2006 (KR) 10-2006-0023700

(51) Int. Cl. H01J 17/49; H01J 1/62

(52) U.S. Cl. 313/582; 313/586; 313/486

(57) ABSTRACT

A plasma display panel and a method for manufacturing the same are disclosed. The plasma display panel includes a front substrate formed with a plurality of sustaining electrode pairs each including a scan electrode and a sustaining electrode, a rear substrate formed with a plurality of address electrodes arranged orthogonal to the sustaining electrode pairs, a plurality of barrier ribs formed on the rear substrate to define a plurality of discharge cells, the barrier ribs containing at least one of pigments with colors respectively corresponding to wavelength bands of lights emitted from the discharge cells, and phosphor layers respectively formed in the plurality of discharge cells, the phosphor layers containing at least one of pigments with colors respectively corresponding to the wavelength bands of the lights emitted from the discharge cells.

This application claims the benefit of Korean Patent Application. No. 10-2006-0023670, filed on Mar. 14, 2006, which is hereby incorporated by reference as if fully set forth herein. Also, this application claims the benefit of Korean Patent Application No. 10-2006-0023698, filed on Mar. 14, 2006, which is hereby incorporated by reference as if fully set forth herein. Also, this application claims the benefit of Korean Patent Application no. 10-2006-0023700, filed on Mar. 14, 2006, which is hereby incorporated by reference as if fully set forth herein. Also, this application claims the benefit of Korean Patent Application No. 10-2006-0023671, filed on Mar. 14, 2006, which is hereby incorporated by reference as if fully set forth herein.

### BACKGROUND

1. Field

This disclosure relates to a plasma display panel and a method for manufacturing the same, and more particularly to a barrier rib and a fluorescent layer in a plasma display panel.

2. Discussion of the Related Art

Generally, plasma display panels are known as a display device in which ultraviolet rays generated in accordance with gas discharge excite phosphors to generate visible rays.

Such a plasma display panel includes discharge cells arranged in the form of a matrix. In FIG. 1, one cell structure of the plasma display panel is shown. As shown in FIG. 1, the plasma display panel includes a front substrate 1 providing an image display surface, and a rear substrate 3 arranged in parallel to the front substrate 1 by barrier ribs 2.

A sustaining electrode pair 4 including a transparent electrode 4a and a bus electrode 4b, an upper dielectric layer 6, and a passivation film 8 are sequentially formed over the front substrate 1. An address electrode 5 and a lower dielectric layer 7 are sequentially formed over the rear substrate 3. The address electrode 5 interacts with the sustaining electrode pair 4 to generate a desired plasma discharge.

A phosphor 9 is coated over the lower dielectric layer 7 such that the phosphor 9 covers the barrier ribs 2, in order to generate visible light with an intrinsic color.

The phosphor 9 is excited by vacuum ultraviolet rays of a short wavelength generated during the gas discharge, thereby generating visible light of red, green, or blue.

In the plasma display panel having the above-mentioned configuration, the phosphor 9 performs a very important function of emitting visible light of red, green, or blue as it is excited by ultraviolet rays generated during the plasma discharge.

Generally, the phosphor 9 is made of a phosphor material having the form of a paste. The phosphor paste has a composition including phosphor powder, a binder for providing a certain viscosity to the phosphor power, and a solvent.

Such a phosphor paste is printed between the adjacent barrier ribs 2, and is then dried. Thereafter, the phosphor paste is subjected to a baking process. However, the phosphor completely formed after the baking process is colored white on the surface thereof.

Due to such a white phosphor, the conventional plasma display panel exhibits high reflectance for external light, and thus exhibits degraded contrast characteristics.

Generally, bright room contrast is referred to as an index for the manufacture of a bright and definite plasma display panel.

Although the importance of bright room contrast has increased in that bright room contrast has been used as a picture quality evaluation item for plasma display panels, no reliable method capable of achieving an improvement in bright room contrast has been proposed yet. For this reason, it is apparent that, in the future, there will be a demand for a plasma display panel having improved bright room contrast, and thus capable of realizing a bright and definite display.

### SUMMARY

Accordingly, the present invention is directed to a plasma display panel and a method for manufacturing the same that substantially obviate one or more problems due to limitations and disadvantages of the related art.

An object of the present invention is to provide a plasma display panel capable of achieving an improvement in bright room contrast while minimizing brightness loss of blue light by barrier ribs containing a blue pigment.

Another object of the present invention is to provide a plasma display panel capable of controlling the body color of the panel.

Still another object of the present invention is to provide a plasma display panel capable of achieving an improvement in bright room contrast while minimizing brightness loss of blue light by barrier ribs containing or coated with a blue pigment, and a method for manufacturing the plasma display panel.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a plasma display panel comprises: a front substrate formed with a plurality of sustaining electrode pairs each including a scan electrode and a sustaining electrode; a rear substrate formed with a plurality of address electrodes arranged orthogonal to the sustaining electrode pairs; a plurality of barrier ribs formed on the rear substrate to define a plurality of discharge cells, the barrier ribs containing at least one of pigments with colors respectively corresponding to wavelength bands of lights emitted from the discharge cells; and phosphor layers respectively formed in the plurality of discharge cells, the phosphor layers containing at least one of pigments with colors respectively corresponding to the wavelength bands of the lights emitted from the discharge cells.

In another aspect of the present invention, a plasma display panel comprises: a front substrate formed with a plurality of sustaining electrode pairs each including a scan electrode and a sustaining electrode; a rear substrate formed with a plurality of address electrodes arranged orthogonal to the sustaining electrode pairs; a plurality of barrier ribs formed on the rear substrate to define a plurality of discharge cells, the barrier ribs being coated with pigments with colors corresponding to wavelength bands of red, green, and blue light emitted from the discharge cells at side and upper surfaces of the barrier ribs facing in respective discharge cells; and phosphor layers respectively formed in the plurality of discharge cells.

In still another aspect of the present invention, a method for manufacturing a plasma display panel comprises: preparing a front substrate formed with a plurality of sustaining electrode pairs each including a scan electrode and a sustaining electrode, and a rear substrate formed with a plurality of address electrodes arranged orthogonal to the sustaining electrode pairs; forming a dielectric layer over the sustaining electrode pairs of the rear substrate; forming a plurality of barrier ribs on the lower dielectric layer, to define a plurality of discharge cells; injecting a pigment comprising at least one of organic and inorganic materials exhibiting red into the first discharge cell, injecting a pigment comprising at least one of organic and inorganic materials exhibiting green into the second discharge cell, and injecting a pigment comprising at least one of organic and inorganic materials exhibiting blue into the third discharge cell; drying the first, second, and third discharge cells filled with the pigments, to maintain the pigments in a state of being coated over side and upper surfaces of the barrier ribs facing in respective discharge cells; forming a red phosphor layer in the first discharge cell; forming a green phosphor layer in the second discharge cell, and forming a blue phosphor layer in the third discharge cell; baking and drying the red, green, and blue phosphor layers; and assembling the front and rear substrates.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view illustrating a general plasma display panel;

FIG. 2 is a sectional view illustrating a plasma display panel according to a first embodiment of the present invention;

FIG. 3 is a graph for comparison of the reflectance of a blue barrier rib used in the first embodiment of the present invention with the reflectance of a conventional barrier rib;

FIG. 4 is a sectional view illustrating a plasma display panel according to a second embodiment of the present invention;

FIGS. 5A to 5C are graphs for comparison of the reflectance of phosphors used in the second embodiment of the present invention with the reflectance of conventional phosphors;

FIG. 6 is a sectional view illustrating a plasma display panel according to a third embodiment of the present invention;

FIG. 7 is a sectional view illustrating a plasma display panel according to a fourth embodiment of the present invention;

FIGS. 8A to 8C are graphs for comparison of the reflectance of barrier ribs used in the third and fourth embodiments of the present invention with the reflectance of the conventional barrier ribs;

FIGS. 9A to 9F are sectional views for explaining manufacturing processes included in a plasma display panel manufacturing method according to an embodiment of the present invention; and

FIG. 10 is a schematic view illustrating an ink jet injection method used in the plasma display panel manufacturing method according to the illustrated embodiment of the present invention.

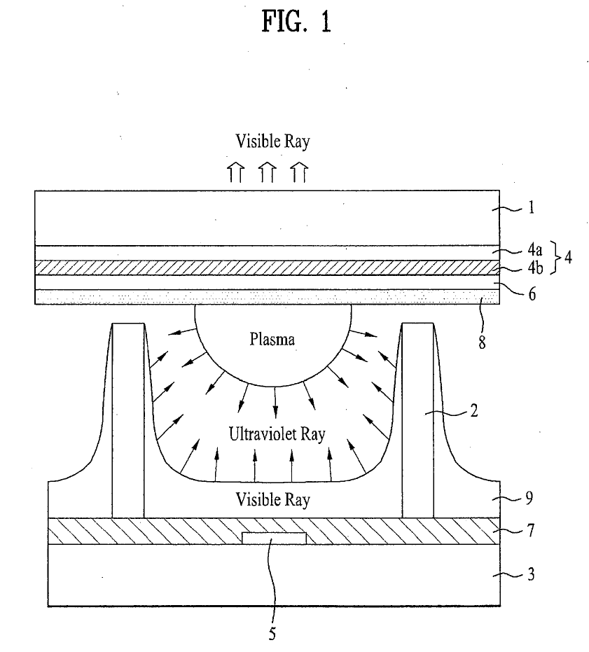

### DETAILED DESCRIPTION

Reference will now be made in detail to the preferred embodiments of the present invention, examples of which are illustrated in the accompanying drawings. Wherever possible, the same reference numbers will be used throughout the drawings to refer to the same or like parts.

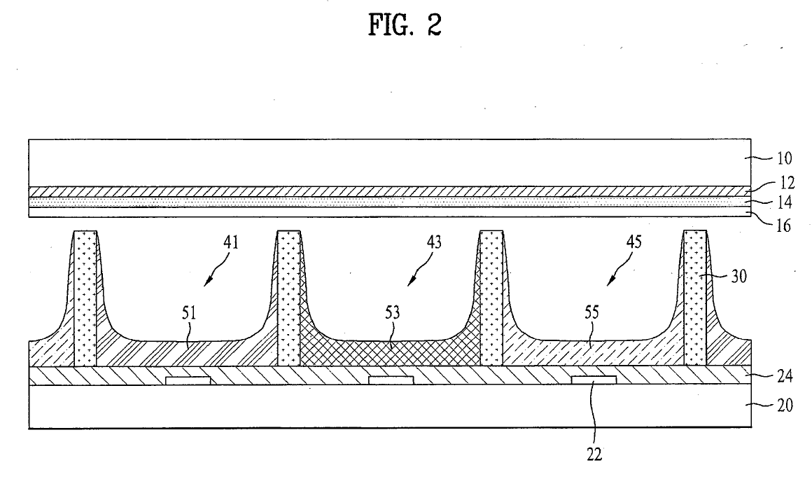

FIG. 2 is a sectional view illustrating a plasma display panel according to a first embodiment of the present invention. The plasma display panel according to the first embodiment of the present invention will be described with reference to FIG. 2.

In accordance with the first embodiment of the present invention, a front substrate 10 and a rear substrate 20 are arranged in parallel while being spaced apart from each other by a certain distance.

A plurality of sustaining electrode pairs 12 each including a scan electrode and a sustaining electrode are first formed over the front panel 10. An upper dielectric layer 14 is then formed over the sustaining electrode pairs 12. A passivation film 16 containing MgO is formed over the upper dielectric layer 14.

Over the rear substrate 20 facing the front substrate 10, a plurality of address electrodes 22 are formed such that they are arranged orthogonal to the sustaining electrode pairs 12 on the front substrate 10. A lower dielectric layer 24 is formed over the address electrodes 22.

A plurality of barrier ribs 30 are formed over the lower dielectric layer 24 of the rear substrate 20, so as to define a plurality of discharge cells 41, 43, and 45. Phosphor layers 51, 53, and 55 are formed in the discharge cells 41, 43, and 45, respectively.

In order to enable the discharge cells 41, 43, and 45 to have a high reflectance in a blue wavelength band, the barrier ribs 30 preferably contain a pigment comprising at least one of organic and inorganic materials exhibiting blue.

The pigment contained in the barrier ribs 30 may be at least one of a cobalt blue pigment, a Prussian pigment, a Turkey blue pigment, and a Co—Zn—Si pigment.

The pigment contained in the barrier ribs 30 may also comprise at least one of CoOAl₂O₃, 2(Co, Zn)O.SiO₂, and ZrSiO₄.

Preferably, each barrier rib 30 comprises 90 to 99.99 wt % of low-melting-point glass powder and 0.01 to 10 wt % of a pigment.

The plurality of discharge cells may comprise a first discharge cell 41 for emitting red light, a second discharge cell 43 for emitting green light, and a third discharge cell 45 for emitting blue light. The phosphor layers may comprise a red phosphor layer 51 formed in the first discharge cell 41 while containing a pigment comprising at least one of organic and inorganic materials exhibiting red, to have a high reflectance at a red wavelength band, a green phosphor layer 53 formed in the second discharge cell 43 while containing a pigment comprising at least one of organic and inorganic materials exhibiting green, to have a high reflectance at a green wavelength band, and a blue phosphor layer 55 formed in the third discharge cell 45 while containing a pigment comprising at least one of organic and inorganic materials exhibiting blue, to have a high reflectance at a blue wavelength band.

The pigment contained in the red phosphor layer 51 may be an iron oxide pigment. The pigment contained in the green phosphor layer 53 may be at least one of a cobalt green pigment, an emerald green pigment, a chromium oxide green pigment, a chromium-alumina green pigment, and a Victoria green pigment. The pigment contained in the blue phosphor layer 55 may be at least one of a cobalt blue pigment, a Prussian pigment, a Turkey blue pigment, and Co—Zn—Si pigment.

The pigment contained in the red phosphor layer 51 may be α-Fe₂O₃. The pigment contained in the red phosphor layer 53 may be at least one of (Co, Zn)O.(Al, Cr)₂O₃, 3CaO—Cr₂O₃.3SiO₂, and (Al, Cr)₂O₃. The pigment contained in the blue phosphor layer 55 may be at least one of CoOAl₂O₃,** 2(Co, Zn)O.SiO₂, and ZrSiO₄.

Each of the red, green, and blue phosphor layers 51, 53, and 55 may comprise 80 to 99.99 wt % of phosphor powder and 0.01 to 20 wt % of a pigment.

Different from the embodiment of FIG. 2, no pigment may be contained in the phosphor layers, and a blue pigment is contained only in the barrier ribs, in accordance with the present invention. In this case, although the reflectance for external light is high, as compared to the embodiment of FIG. 2, there are advantages in that it is possible to reduce the brightness loss of blue light and to simplify the manufacturing process.

The above-described plasma display panel according to the first embodiment of the present invention can effectively reduce the reflectance for external light and the brightness loss of blue light exhibiting a low brightness due to reflection of blue light, in accordance of the addition of a blue pigment to the barrier ribs, as compared to conventional cases in which the barrier ribs thereof exhibit white, thereby causing an increased reflectance for external light and thus a degraded bright room contrast. Furthermore, in accordance with the first embodiment of the present invention, it is possible to reduce the reflectance for incident light by the red phosphor layer containing a red pigment, the green phosphor layer containing a green pigment, and the blue phosphor layer containing a blue pigment, and thus to improve the bright room contrast and to minimize the total brightness loss.

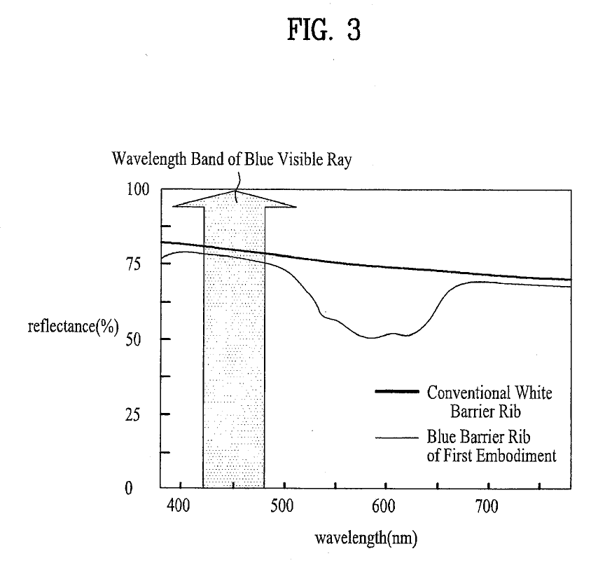

FIG. 3 is a graph for comparison of the reflectance of the blue barrier rib used in the first embodiment of the present invention with the reflectance of the conventional barrier rib.

As shown in FIG. 3, the blue barrier rib containing a blue pigment exhibits a high reflectance in a wavelength band of about 400 to 500 nm while exhibiting a relatively low reflectance in other wavelength bands.

Accordingly, the blue barrier rib has advantages in that it can achieve an improvement in bright room contrast by virtue of a low reflectance at wavelength bands other than a blue wavelength band, and can achieve a reduction in the brightness loss of blue light by virtue of a high reflectance at the blue wavelength band.

Since the plasma display panel according to the first embodiment of the present invention uses blue barrier ribs containing a blue pigment, it has an elegant appearance in that the body of the panel totally exhibits blue.

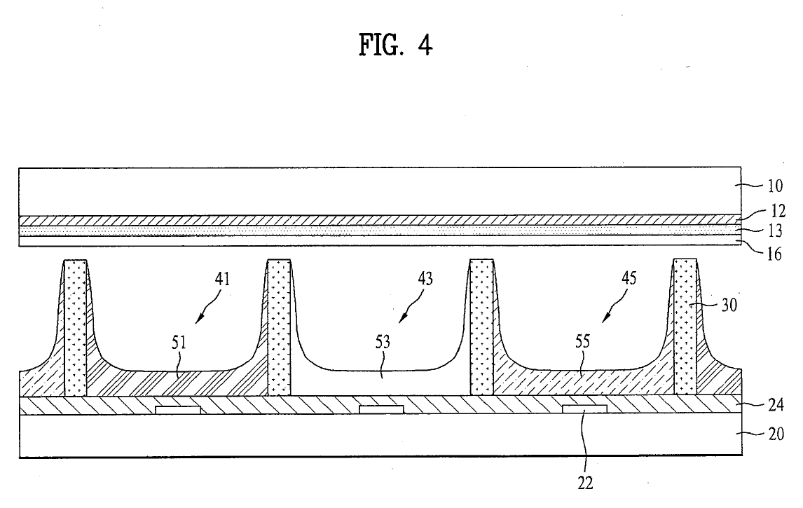

FIG. 4 is a sectional view illustrating a plasma display panel according to a second embodiment of the present invention. The plasma display panel according to the second embodiment of the present invention will be described with reference to FIG. 4.

In accordance with the second embodiment of the present invention, a front substrate 10 and a rear substrate 20 are arranged in parallel while being spaced apart from each other by a certain distance.

A plurality of sustaining electrode pairs 12 each including a scan electrode and a sustaining electrode are first formed over the front panel 10. An upper dielectric layer 14 is then formed over the sustaining electrode pairs 12. A passivation film 16 containing MgO is formed over the upper dielectric layer 14.

Over the rear substrate 20 facing the front substrate 10, a plurality of address electrodes 22 are formed such that they are arranged orthogonal to the sustaining electrode pairs 12 on the front substrate 10. A lower dielectric layer 24 is formed over the address electrodes 22.

A plurality of barrier ribs 30 are formed over the lower dielectric layer 24 of the rear substrate 20, so as to define a plurality of discharge cells 41, 43, and 45. Phosphor layers 51, 53, and 55 are formed in the discharge cells 41, 43, and 45, respectively.

In order to enable the discharge cells 41, 43, and 45 to have a high reflectance in a green wavelength band, the barrier ribs 30 preferably contain a pigment comprising at least one of organic and inorganic materials exhibiting green.

The pigment contained in the barrier ribs 30 may be at least one of a cobalt green pigment, an emerald green pigment, a chromium oxide green pigment, a chromium-alumina green pigment, and Victoria green pigment.

The pigment contained in the barrier ribs 30 may also comprise at least one of (Co, Zn)O.(Al, Cr)₂O₃, 3CaO—Cr₂O₃.3SiO₂, and (Al, Cr)₂O₃.

Preferably, each barrier rib 30 comprises 90 to 99.99 wt % of low-melting-point glass powder and 0.01 to 10 wt % of a pigment.

The plurality of discharge cells may comprise a first discharge cell 41 for emitting red light, a second discharge cell 43 for emitting green light, and a third discharge cell 45 for emitting blue light. The phosphor layers may comprise a red phosphor layer 51 formed in the first discharge cell 41 while containing a pigment comprising at least one of organic and inorganic materials exhibiting red, to have a high reflectance at a red wavelength band, a green phosphor layer 53 formed in the second discharge cell 43 without containing any pigment, and a blue phosphor layer 55 formed in the third discharge cell 45 while containing a pigment comprising at least one of organic and inorganic materials exhibiting blue, to have a high reflectance at a blue wavelength band.

The pigment contained in the red phosphor layer 51 may be an iron oxide pigment. The pigment contained in the blue phosphor layer 55 may be at least one of a cobalt blue pigment, a Prussian pigment, a Turkey blue pigment, and a Co—Zn—Si pigment.

The pigment contained in the red phosphor layer 51 may be α-Fe₂O₃. The pigment contained in the blue phosphor layer 55 may be at least one of CoOAl₂O₃, 2(Co, Zn)O.SiO₂, and ZrSiO₄.

Each of the red and blue phosphor layers 51 and 55 may comprise 80 to 99.99 wt % of phosphor powder and 0.01 to 20 wt % of a pigment.

In the above-described plasma display panel according to the second embodiment of the present invention, the barrier ribs contain a green pigment, and no pigment is contained in the green phosphor layer, taking into the following reasons.

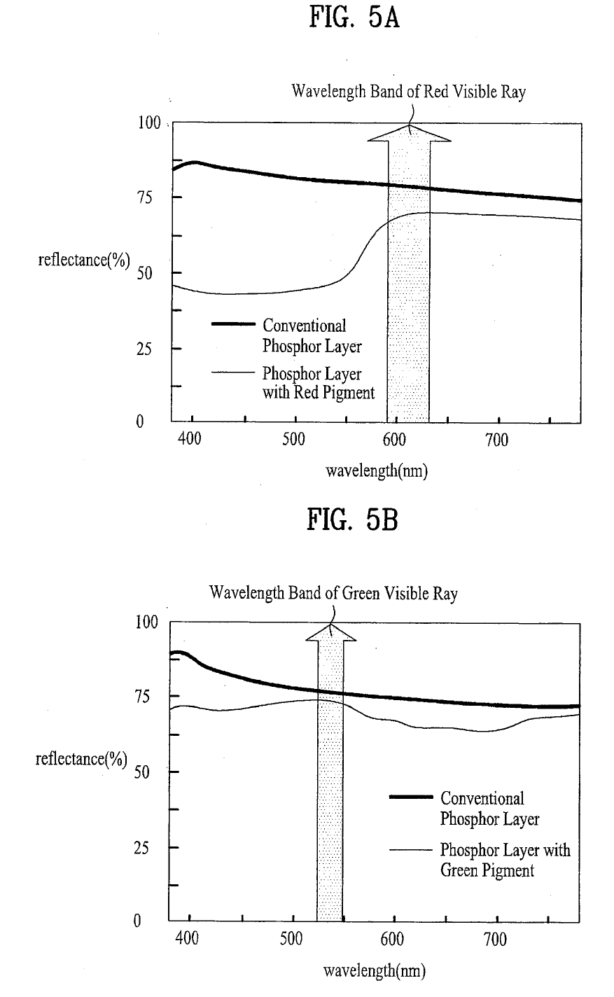

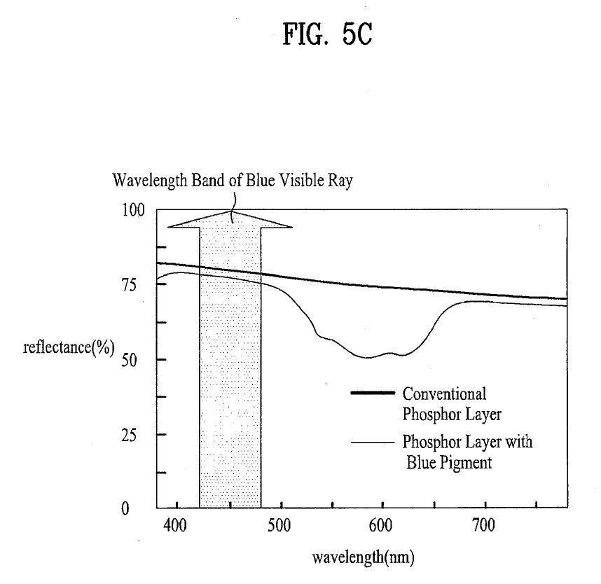

FIGS. 5A to 5C are graphs for comparison of the reflectance of the phosphors used in the second embodiment of the present invention with the reflectance of the conventional phosphors.

FIG. 5A is a graph for comparison of the reflectance of a red phosphor layer containing a red pigment with the reflectance of the conventional phosphor layer. FIG. 5B is a graph for comparison of the reflectance of a green phosphor layer containing a green pigment with the conventional phosphor layer. FIG. 5C is a graph for comparison of the reflectance of a blue phosphor layer containing a blue pigment with the reflectance of the conventional phosphor layer.

As shown in FIG. 5A, the red phosphor layer containing the red pigment exhibits a high reflectance in a wavelength band of about 550 to 650 nm while exhibiting a relatively low reflectance in other wavelength bands.

Accordingly, the red phosphor layer containing the red pigment has advantages in that it can achieve an improvement in bright room contrast by virtue of a low reflectance at wavelength bands other than a red wavelength band, and can achieve an increase in red purity by virtue of a high reflectance at the red wavelength band.

As shown in FIG. 5C, the blue phosphor layer containing the blue pigment exhibits a high reflectance in a wavelength band of about 400 to 500 nm while exhibiting a relatively low reflectance in other wavelength bands.

Accordingly, the blue phosphor layer containing the blue pigment has advantages in that it can achieve an improvement in bright room contrast by virtue of a low reflectance at wavelength bands other than a blue wavelength band, and can achieve an increase in blue purity by virtue of a high reflectance at the blue wavelength band.

As shown in FIG. 5B, the green phosphor layer containing the green pigment exhibits a high reflectance in a wavelength band of about 500 to 600 nm while exhibiting a relatively low reflectance in other wavelength bands. In the green phosphor layer, however, the difference between the reflectance in the green wavelength band and the reflectance in other wavelength bands is not considerable.

For this reason, the bright room contrast improvement of the green phosphor layer is not considerable, as compared to the other phosphor layers.

Furthermore, the phosphor layers respectively containing red, green, and blue pigments may exhibit a brightness loss even though they improve the total bright room contrast of the panel.

In the plasma display panel according to the second embodiment of the present invention, accordingly, pigments are added only to the red and blue phosphor layers to achieve an improvement in bright room contrast, and no pigment is added to the green phosphor layer, to minimize the brightness loss.

However, when pigments are contained only in the red and blue phosphor layers the panel may exhibit red because the red phosphor layer containing the red pigment exhibits high light absorption, as compared to the phosphor layers containing pigments other than the red pigment.

For this reason, in the plasma display panel according to the second embodiment of the present invention, a green pigment is contained in the barrier ribs, to adjust the body color of the panel and to contribute to a reduction in reflectance for external light.

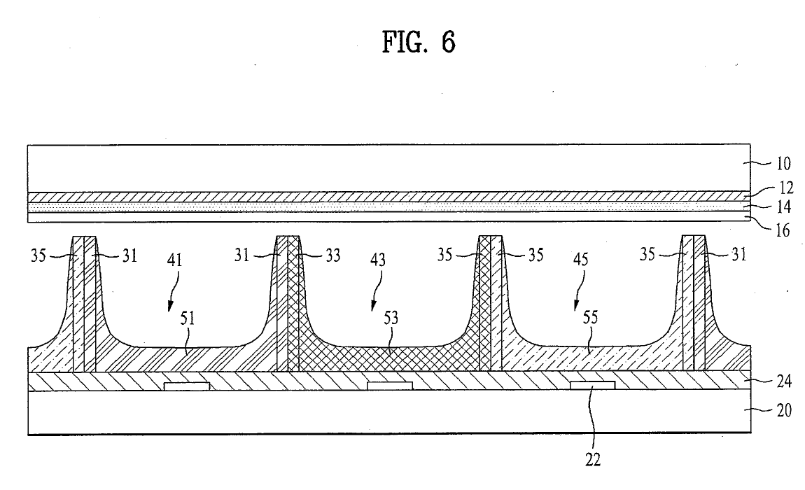

FIG. 6 is a sectional view illustrating a plasma display panel according to a third embodiment of the present invention. The plasma display panel according to the third embodiment of the present invention will be described with reference to FIG. 6.

In accordance with the third embodiment of the present invention, a front substrate 10 and a rear substrate 20 are arranged in parallel while being spaced apart from each other by a certain distance.

A plurality of sustaining electrode pairs 12 each including a scan electrode and a sustaining electrode are first formed over the front panel 10. An upper dielectric layer 14 is then formed over the sustaining electrode pairs 12. A passivation film 16 containing MgO is formed over the upper dielectric layer 14.

Over the rear substrate 20 facing the front substrate 10, a plurality of address electrodes 22 are formed such that they are arranged orthogonal to the sustaining electrode pairs 12 on the front substrate 10. A lower dielectric layer 24 is formed over the address electrodes 22.

A plurality of barrier ribs 31, 33, and 35 are formed over the lower dielectric layer 24 of the rear substrate 20, so as to define a plurality of discharge cells 41, 43, and 45, respectively. Phosphor layers 51, 53, and 55 are formed in the discharge cells 41, 43, and 45, respectively.

In this case, the barrier ribs 31, 33, and 35 preferably contain pigments respectively corresponding to red, green, and blue light emitted from the discharge cells 41, 43, and 45.

The plurality of discharge cells may comprise a first discharge cell 41 for emitting red light, a second discharge cell 43 for emitting green light, and a third discharge cell 45 for emitting blue light. The barrier ribs may comprise a first barrier rib 31 formed to surround the first discharge cell 41 while containing a pigment comprising at least one of organic and inorganic materials exhibiting red, to have a high reflectance at a red wavelength band, a second barrier rib 33 formed to surround the second discharge cell 43 while containing a pigment comprising at least one of organic and inorganic materials exhibiting green, to have a high reflectance at a green wavelength band, and a third barrier rib 35 formed to surround the third discharge cell 45 while containing a pigment comprising at least one of organic and inorganic materials exhibiting blue, to have a high reflectance at a blue wavelength band.

The adjacent ones of the first, second, and third barrier ribs 31, 33, and 35 may be attached to each other at facing side surfaces thereof or may be spaced apart from each other. In the case of FIG. 6, the plasma display panel according to the third embodiment of the present invention has a structure in which the facing side surfaces of the adjacent barrier ribs are attached to each other.

The pigment contained in the first barrier wall 31 may be an iron oxide pigment which exhibits a high reflectance in a red wavelength band while exhibiting a relatively low reflectance in other wavelength bands.

The pigment contained in the first barrier wall 31 may be α-Fe₂O₃.

The pigment contained in the second barrier wall 33 may be at least one of a cobalt green pigment, an emerald green pigment, a chromium oxide green pigment, a chromium-alumina green pigment, and a Victoria green pigment which exhibit a high reflectance in a green wavelength band while exhibiting a relatively low reflectance in other wavelength bands.

The pigment contained in the second barrier rib 33 may be at least one of (Co, Zn)O.(Al, Cr)₂O₃, 3CaO—Cr₂O₃.3SiO₂, and (Al, Cr)₂O₃.

The pigment contained in the third barrier rib 35 may be at least one of a cobalt blue pigment, a Prussian pigment, a Turkey blue pigment, and Co—Zn—Si pigment which exhibit a high reflectance in a blue wavelength band while exhibiting a relatively low reflectance in other wavelength bands.

The pigment contained in the third barrier rib 35 may be at least one of CoOAl₂O₃, 2(Co, Zn)O.SiO₂, and ZrSiO₄.

Preferably, each of the barrier ribs 31, 33, and 35 comprises 90 to 99.99 wt % of low-melting-point glass powder and 0.01 to 10 wt % of a pigment.

The phosphor layers may comprise a red phosphor layer 51 formed in the first discharge cell 41 while containing a pigment comprising at least one of organic and inorganic materials exhibiting red, to have a high reflectance at a red wavelength band, a green phosphor layer 53 formed in the second discharge cell 43 while containing a pigment comprising at least one of organic and inorganic materials exhibiting green, to have a high reflectance at a green wavelength band, and a blue phosphor layer 55 formed in the third discharge cell 45 while containing a pigment comprising at least one of organic and inorganic materials exhibiting blue, to have a high reflectance at a blue wavelength band.

The pigment contained in the red phosphor layer 51 may be an iron oxide pigment. The pigment contained in the green phosphor layer 53 may be at least one of a cobalt green pigment, an emerald green pigment, a chromium oxide green pigment, a chromium-alumina green pigment, and a Victoria green pigment. The pigment contained in the blue phosphor layer 55 may be at least one of a cobalt blue pigment, a Prussian pigment, a Turkey blue pigment, and Co—Zn—Si pigment.

The pigment contained in the red phosphor layer 51 may be α-Fe₂O₃. The pigment contained in the red phosphor layer 53 may be at least one of (Co, Zn)O.(Al, Cr)₂O₃, 3CaO—Cr₂O₃.3SiO₂, and (Al, Cr)₂O₃. The pigment contained in the blue phosphor layer 55 may be at least one of CoOAl₂O₃, 2(Co, Zn)O.SiO₂, and ZrSiO₄.

Each of the red, green, and blue phosphor layers 51, 53, and 55 may comprise 80 to 99.99 wt % of phosphor powder and 0.01 to 20 wt % of a pigment.

Although the red, green, and blue phosphor layers 51, 53, and 55 in the plasma display panel according to the third embodiment of the present invention contain pigments respectively corresponding to red, green, and blue wavelength bands, they may not contain such pigments, if necessary.

Where pigments are contained in the phosphor layers, the pigments contained in the red, green, and blue phosphor layers 51, 53, and 55 may be identical to or different from the pigments contained in the first, second, and third barrier ribs 31, 33, and 35.

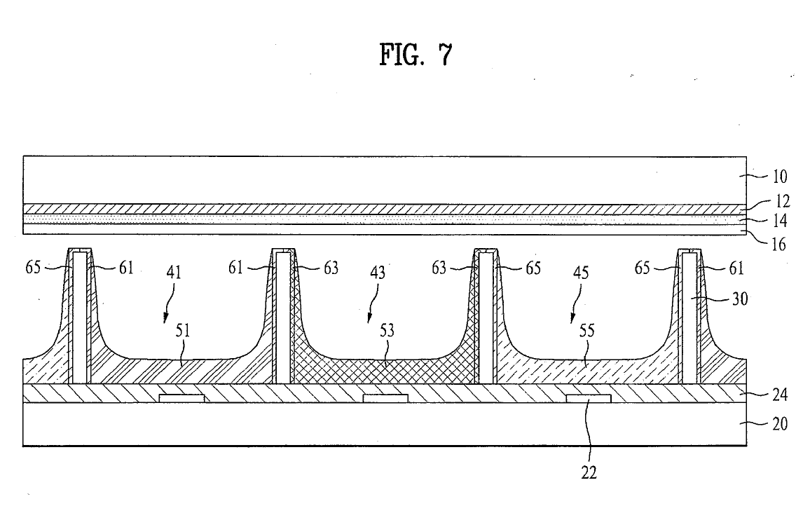

FIG. 7 is a sectional view illustrating a plasma display panel according to a fourth embodiment of the present invention. The plasma display panel according to the fourth embodiment of the present invention will be described with reference to FIG. 7.

In accordance with the fourth embodiment of the present invention, a front substrate 10 and a rear substrate 20 are arranged in parallel while being spaced apart from each other by a certain distance.

A plurality of sustaining electrode pairs 12 each including a scan electrode and a sustaining electrode are first formed over the front panel 10. An upper dielectric layer 14 is then formed over the sustaining electrode pairs 12. A passivation film 16 containing MgO is formed over the upper dielectric layer 14.

Over the rear substrate 20 facing the front substrate 10, a plurality of address electrodes 22 are formed such that they are arranged orthogonal to the sustaining electrode pairs 12 on the front substrate 10. A lower dielectric layer 24 is formed over the address electrodes 22.

A plurality of barrier ribs 30 are formed over the lower dielectric layer 24 of the rear substrate 20, so as to define a plurality of discharge cells 41, 43, and 45. Pigments 61, 63, and 65 of colors respectively corresponding to light of red, green, and blue wavelength bands emitted from the discharge cells 41, 43, and 45 are coated over the side and upper surfaces of the barrier ribs 30 facing in respective discharge cells 41, 43, and 45.

Phosphor layers 51, 53, and 55 are formed in the discharge cells 41, 43, and 45, respectively.

The plurality of discharge cells may comprise a first discharge cell 41 for emitting red light, a second discharge cell 43 for emitting green light, and a third discharge cell 45 for emitting blue light.

An iron oxide pigment exhibiting a high reflectance at a red wavelength band while exhibiting a low reflectance at other wavelength bands may be coated over the side and upper surfaces of the barrier ribs 30 facing in the first discharge cell 41 emitting light of the red wavelength band. At least one of a cobalt green pigment, an emerald green pigment, a chromium oxide green pigment, a chromium-alumina green pigment, and a Victoria green pigment, which exhibit a high reflectance at a green wavelength band while exhibiting a low reflectance at other wavelength bands may be coated over the side and upper surfaces of the barrier ribs 30 facing in the second discharge cell 43 emitting light of the green wavelength band. At least one of a cobalt blue pigment, a Prussian pigment, a Turkey blue pigment, and Co—Zn—Si pigment, which exhibit a high reflectance at a blue wavelength band while exhibiting a low reflectance at other wavelength bands may be coated over the side and upper surfaces of the barrier ribs 30 facing in the third discharge cell 45 emitting light of the blue wavelength band.

A pigment of oα-Fe₂O₃ may be coated over the side and upper surfaces of the barrier ribs 30 facing in the first discharge cell 41 emitting light of the red wavelength band. At least one of (Co, Zn)O.(Al, Cr)₂O₃, 3CaO—Cr₂O₃.3SiO₂, and (Al, Cr)₂O₃ may be coated over the side and upper surfaces of the barrier ribs 30 facing in the second discharge cell 43 emitting light of the green wavelength band. At least one of CoOAl₂O₃, 2(Co, Zn)O.SiO₂, and ZrSiO₄ may be coated over the side and upper surfaces of the barrier ribs 30 facing in the third discharge cell 45 emitting light of the blue wavelength band.

The phosphor layers may comprise a red phosphor layer 51 formed in the first discharge cell 41 while containing a pigment comprising at least one of organic and inorganic materials exhibiting red, to have a high reflectance at the red wavelength band, a green phosphor layer 53 formed in the second discharge cell 43 while containing a pigment comprising at least one of organic and inorganic materials exhibiting green, to have a high reflectance at the green wavelength band, and a blue phosphor layer 55 formed in the third discharge cell 45 while containing a pigment comprising at least one of organic and inorganic materials exhibiting blue, to have a high reflectance at the blue wavelength band.

The pigment contained in the red phosphor layer 51 may be an iron oxide pigment. The pigment contained in the green phosphor layer 53 may be at least one of a cobalt green pigment, an emerald green pigment, a chromium oxide green pigment, a chromium-alumina green pigment, and a Victoria green pigment. The pigment contained in the blue phosphor layer 55 may be at least one of a cobalt blue pigment, a Prussian pigment, a Turkey blue pigment, and Co—Zn—Si pigment.

The pigment contained in the red phosphor layer 51 may be α-Fe₂O₃. The pigment contained in the red phosphor layer 53 may be at least one of (Co, Zn)O.(Al, Cr)₂O₃, 3CaO—Cr₂O₃.3SiO₂, and (Al, Cr)₂O₃. The pigment contained in the blue phosphor layer 55 may be at least one of CoOAl₂O₃, 2(Co, Zn)O.SiO₂, and ZrSiO₄.

Each of the red, green, and blue phosphor layers 51, 53, and 55 may comprise 80 to 99.99 wt % of phosphor powder and 0.01 to 20 wt % of a pigment.

Although the red, green, and blue phosphor layers 51, 53, and 55 in the plasma display panel according to the third embodiment of the present invention contain pigments respectively corresponding to red, green, and blue wavelength bands, they may not contain such pigments, if necessary.

Where pigments are contained in the phosphor layers, the pigments contained in the red, green, and blue phosphor layers 51, 53, and 55 may be identical to or different from the pigments coated over the barrier ribs 30.

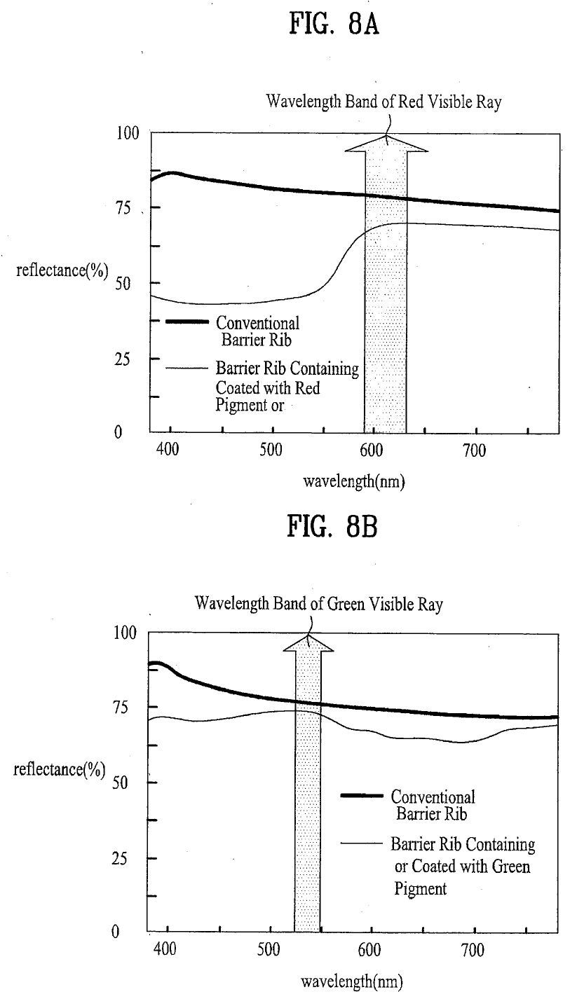

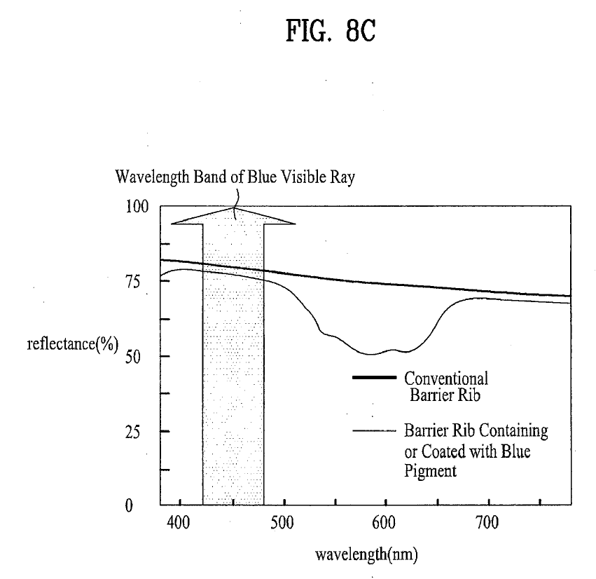

FIGS. 8A to 8C are graphs for comparison of the reflectance of the barrier ribs used in the third and fourth embodiments of the present invention with the reflectance of the conventional barrier ribs.

As shown in FIG. 8A, the barrier rib containing or coated with the red pigment exhibits a high reflectance in a wavelength band of about 550 to 650 nm while exhibiting a relatively low reflectance in other wavelength bands.

As shown in FIG. 8B, the barrier rib containing or coated with the green pigment exhibits a high reflectance in a wavelength band of about 500 to 600 nm while exhibiting a relatively low reflectance in other wavelength bands.

As shown in FIG. 8C, the barrier rib containing or coated with the blue pigment exhibits a high reflectance in a wavelength band of about 400 to 500 nm while exhibiting a relatively low reflectance in other wavelength bands.

Accordingly, in the plasma display panel according to the third or fourth embodiment of the present invention, the barrier rib containing or coated with the red, green, or blue pigment has advantages in that it can achieve an improvement in bright room contrast by virtue of a low reflectance at wavelength bands other than the wavelength band corresponding to the associated color, and can achieve a reduction in the brightness loss of the associated color by virtue of a high reflectance at the wavelength band corresponding to the associated color.

In addition, in the plasma display panel according to the third or fourth embodiment of the present invention, the reflectance for incident light is reduced by the pigment contained in each phosphor layer. Accordingly, it is possible to achieve an improvement in bright room contrast and to minimize the total brightness loss of the panel.

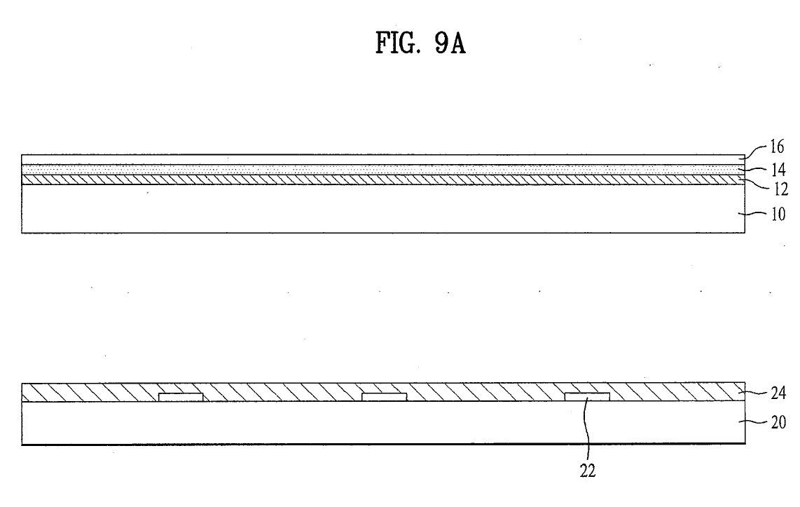

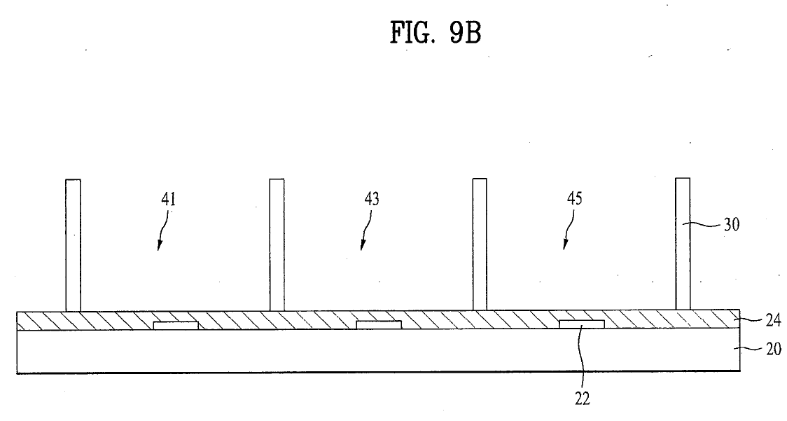

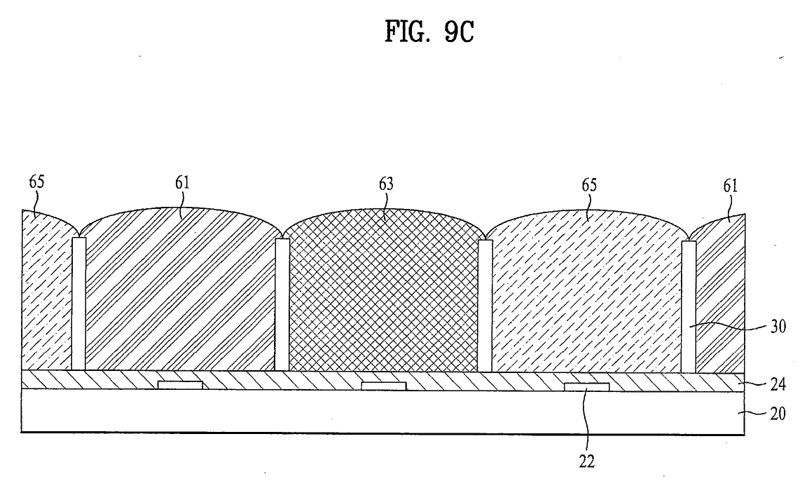

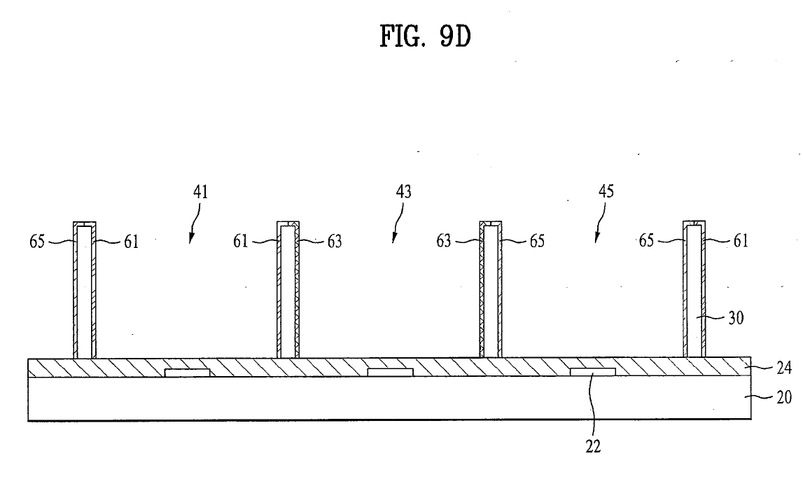

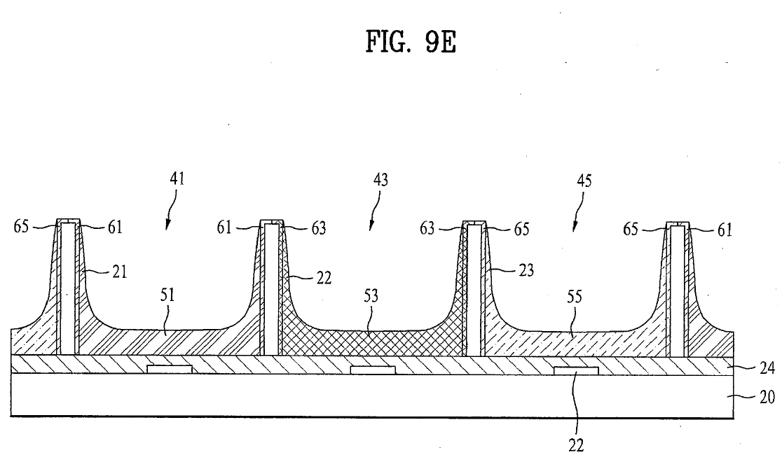

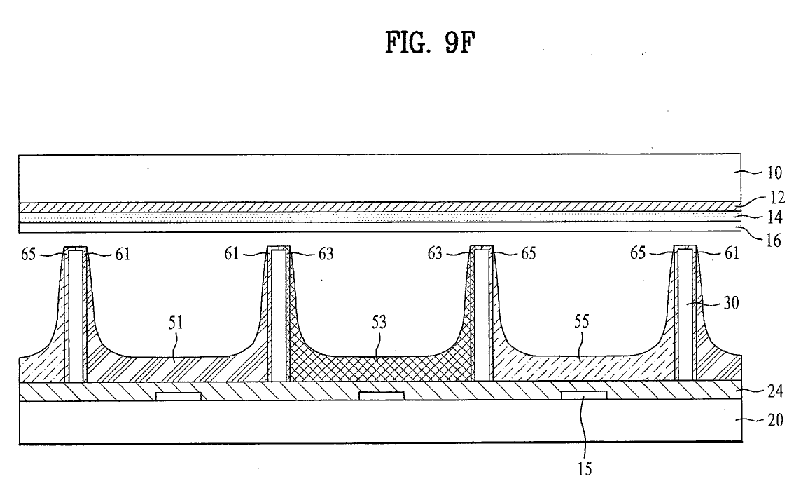

FIGS. 9A to 9F are sectional views for explaining manufacturing processes included in a method for manufacturing the above-described plasma display panel in accordance with an embodiment of the present invention. The plasma display panel manufacturing method according to the illustrated embodiment will be described with reference to FIGS. 9A to 9F.

First, a front substrate 10 formed with a plurality of sustaining electrode pairs 12 each including a scan electrode and a sustaining electrode is prepared, as shown in FIG. 9A. A rear substrate 20 formed with a plurality of address electrodes 22 arranged orthogonal to the sustaining electrode pairs 12 is also prepared.

An upper dielectric layer 14 is then formed over the sustaining electrode pairs 12. Also, a passivation film 16 containing MgO is formed over the upper dielectric layer 14.

Thereafter, a lower dielectric layer 24 is formed over the address electrodes 22 of the rear substrate 20.

Subsequently, a plurality of barrier ribs 30 are formed on the lower dielectric layer 24, so as to define a plurality of discharge cells 41, 43, and 45, as shown in FIG. 9B.

A pigment 61 comprising at least one of organic and inorganic materials exhibiting red is then injected into the first discharge cell 41, as shown in FIG. 9C. Also, a pigment 63 comprising at least one of organic and inorganic materials exhibiting green is then injected into the second discharge cell 43. A pigment 65 comprising at least one of organic and inorganic materials exhibiting blue is also injected into the third discharge cell 45.

The pigment 61 injected into the first discharge cell 41 may be an iron oxide pigment exhibiting a high reflectance in a red wavelength band while exhibiting a relatively low reflectance in other wavelength bands. The pigment 63 injected into the second discharge cell 43 may be at least one of a cobalt green pigment, an emerald green pigment, a chromium oxide green pigment, a chromium-alumina green pigment, and a Victoria green pigment which exhibit a high reflectance in a green wavelength band while exhibit a relatively low reflectance in other wavelength bands. The pigment 65 injected into the third discharge cell 45 may be at least one of a cobalt blue pigment, a Prussian pigment, a Turkey blue pigment, and a Co—Zn—Si pigment which exhibit a high reflectance in a blue wavelength band while exhibit a relatively low reflectance in other wavelength bands.

The pigment 61 injected into the first discharge cell 41 may be α-Fe₂O₃. The pigment 63 injected into the second discharge cell 43 may be at least one of (Co, Zn)O.(Al, Cr)₂O₃, 3CaO—Cr₂O₃.3SiO₂, and (Al, Cr)₂O₃. The pigment 65 injected into the third discharge cell 45 may be at least one of CoOAl₂O₃, 2(Co, Zn)O.SiO₂, and ZrSiO₄.

The injection of the pigments 61, 63, and 65 may be achieved using a dispensing method or an ink jet injection method.

Preferably, the injection of the pigments 61, 63, and 65 is carried out such that each pigment fills the associated discharge cell to completely cover the associated barrier ribs 30 up to the upper surface of the barrier ribs 30.

Thereafter, as shown in FIG. 9D, the first, second, and third discharge cells 41, 43, and 45 filled with the pigments 61, 63, and 65 are dried at a temperature of about 400 to 600° C. Thus, each pigment is coated over the side and upper surfaces of the barrier ribs 30 facing in the associated discharge cell.

Subsequently, as shown in FIG. 9E, a red phosphor layer 51 is formed in the first discharge cell 41. Also, a green phosphor layer 53 is formed in the second discharge cell 43. A blue phosphor layer 55 is also formed in the third discharge cell 45.

The red, green, and blue phosphor layers 51, 53, and 55 may contain pigments to obtain a reduction in the reflectance for external light and an increase in brightness, or may not contain such pigments.

The pigments contained in the red, green, and blue phosphor layers 51, 53, and 55 may be identical to or different from the pigments coated over the associated barrier ribs.

The red, green, and blue phosphor layers 51, 53, and 55 are then baked and dried.

Finally, as shown in FIG. 9F, the front substrate 10 and rear substrate 20 are assembled under the condition in which they are arranged in parallel while being spaced apart from each other by a certain distance. Thus, the manufacture of the plasma display panel is completed.

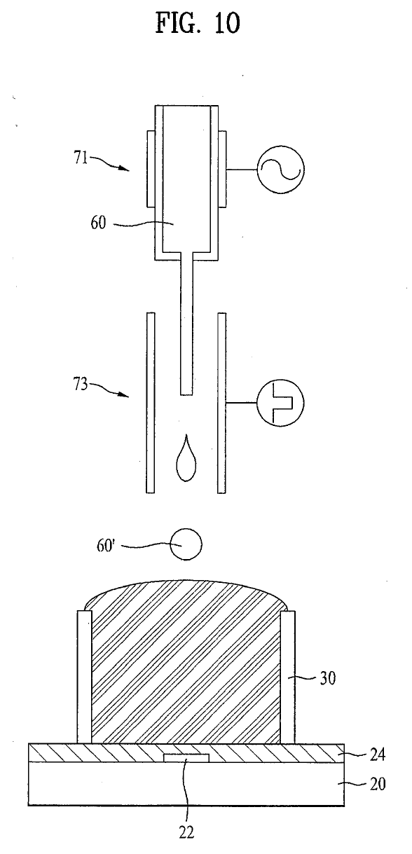

FIG. 10 is a schematic view illustrating an ink jet injection method used in the plasma display panel manufacturing method according to the illustrated embodiment of the present invention.

As shown in FIG. 10, a pigment ink 60 to fill each cell is filled in an ink jet head 71.

The pigment ink 60 is changed into pigment ink droplets 60′ while passing through a charge electrode. The droplets 60′ are injected into the cells defined among the barrier ribs 30, so as to fill the cells.

Preferably, the pigment ink 60 fills each cell such that it covers each barrier rib 30 up to the upper surface of the barrier rib 30. This is because the pigment should be coated over each barrier rib 30 up to the upper surface of the barrier rib 30, in order to reduce the reflectance for external light reflected from the barrier rib.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A plasma display panel comprising:
a front substrate formed with a plurality of sustaining electrode pairs each including a scan electrode and a sustaining electrode;
a rear substrate formed with a plurality of address electrodes arranged orthogonal to the sustaining electrode pairs;
a plurality of barrier ribs formed on the rear substrate to define a plurality of discharge cells, the barrier ribs containing at least one of pigments with colors respectively corresponding to wavelength bands of lights emitted from the discharge cells; and
phosphor layers respectively formed in the plurality of discharge cells, the phosphor layers containing at least one of pigments with colors respectively corresponding to the wavelength bands of the lights emitted from the discharge cells.

2. The plasma display panel according to claim 1, wherein each barrier rib comprises 90 to 99.99 wt % of low-melting-point glass powder, and the pigment contained in the barrier rib has a content of 0.01 to 10 wt %.

3. The plasma display panel according to claim 1, wherein the pigment contained in each barrier rib comprises at least one of organic and inorganic materials exhibiting blue.

4. The plasma display panel according to claim 3, wherein the pigment contained in each barrier rib comprises at least one of CoOAl₂O₃, 2(Co, Zn)O.SiO₂, and ZrSiO₄.

5. The plasma display panel according to claim 3, wherein:
the plurality of discharge cells comprise a first discharge cell emitting red light, a second discharge cell emitting green light, and a third discharge cell emitting blue light; and
the phosphor layers comprise a red phosphor layer formed in the first discharge cell while containing a pigment comprising at least one of organic and inorganic materials exhibiting red, a green phosphor layer formed in the second discharge cell while containing a pigment comprising at least one of organic and inorganic materials exhibiting green, and a blue phosphor layer formed in the third discharge cell while containing a pigment comprising at least one of organic and inorganic materials exhibiting blue.

6. The plasma display panel according to claim 5, wherein:
the pigment contained in the red phosphor layer comprises α-Fe₂O₃;
the pigment contained in the red phosphor layer comprises at least one of (Co, Zn)O.(Al, Cr)₂O₃, 3CaO—Cr₂O₃.3SiO₂, and (Al, Cr)₂O₃; and
the pigment contained in the blue phosphor layer comprises at least one of CoOAl₂O₃, 2(Co, Zn)O.SiO₂, and ZrSiO₄.

7. The plasma display panel according to claim 5, wherein each of the red, green, and blue phosphor layers comprises 80 to 99.99 wt % of phosphor powder, and the pigment contained in the phosphor layer has a content of 0.01 to 20 wt %.

8. The plasma display panel according to claim 1, wherein the pigment contained in each barrier rib comprises at least one of organic and inorganic materials exhibiting green.

9. The plasma display panel according to claim 8, wherein the pigment contained in each barrier rib comprises at least one of (Co, Zn)O (Al, Cr)₂O₃, 3CaO—Cr₂O₃.3SiO₂ and (Al, Cr)₂O₃.

10. The plasma display panel according to claim 8, wherein:
the plurality of discharge cells comprise a first discharge cell emitting red light, a second discharge cell emitting green light, and a third discharge cell emitting blue light; and
the phosphor layers comprise a red phosphor layer formed in the first discharge cell while containing a pigment comprising at least one of organic and inorganic materials exhibiting red, a green phosphor layer formed in the second discharge cell, and a blue phosphor layer formed in the third discharge cell while containing a pigment comprising at least one of organic and inorganic materials exhibiting blue.

11. The plasma display panel according to claim 1, wherein the barrier ribs contain pigments with colors corresponding to red, green, and blue lights emitted from the plurality of discharge cells, respectively.

12. The plasma display panel according to claim 11, wherein:
the plurality of discharge cells comprise a first discharge cell emitting red light, a second discharge cell emitting green light, and a third discharge cell emitting blue light; and
the barrier ribs comprise a first barrier rib formed to surround the first discharge cell while containing a pigment comprising at least one of organic and inorganic materials exhibiting red, a second barrier rib formed to surround the second discharge cell while containing a pigment comprising at least one of organic and inorganic materials exhibiting green, and a third barrier rib formed to surround the third discharge cell while containing a pigment comprising at least one of organic and inorganic materials exhibiting blue.

13. The plasma display panel according to claim 12, wherein adjacent ones of the first, second, and third barrier ribs are attached to or spaced apart from each other.

14. The plasma display panel according to claim 12, wherein the pigment contained in the first barrier rib comprises α-Fe₂O₃.

15. The plasma display panel according to claim 12, wherein the pigment contained in the second barrier rib comprises at least one of (Co, Zn)O.(Al, Cr)₂O₃, 3CaO—Cr₂O₃.3SiO₂, and (Al, Cr)₂O₃.

16. The plasma display panel according to claim 12, wherein the pigment contained in the third barrier rib comprises at least one of CoOAl₂O₃, 2(Co, Zn)O.SiO₂, and ZrSiO₄.

17. A plasma display panel comprising:
a front substrate formed with a plurality of sustaining electrode pairs each including a scan electrode and a sustaining electrode;
a rear substrate formed with a plurality of address electrodes arranged orthogonal to the sustaining electrode pairs;
a plurality of barrier ribs formed on the rear substrate to define a plurality of discharge cells, the barrier ribs being coated with pigments with colors corresponding to wavelength bands of red, green, and blue light emitted from the discharge cells at side and upper surfaces of the barrier ribs facing in respective discharge cells; and
phosphor layers respectively formed in the plurality of discharge cells.

18. The plasma display panel according to claim 17, wherein:
a pigment of oα-Fe₂O₃ is coated over the side and upper surfaces of the barrier ribs facing in the discharge cell emitting light of the red wavelength band;
at least one of (Co, Zn)O (Al, Cr)₂O₃, 3CaO—Cr₂O₃.3SiO₂, and (Al, Cr)₂O₃ is coated over the side and upper surfaces of the barrier ribs facing in the discharge cell emitting light of the green wavelength band; and
at least one of CoOAl₂O₃, 2(Co, Zn)O.SiO₂, and ZrSiO₄ is coated over the side and upper surfaces of the barrier ribs facing in the discharge cell emitting light of the blue wavelength band.

19. A method for manufacturing a plasma display panel, comprising:
preparing a front substrate formed with a plurality of sustaining electrode pairs each including a scan electrode and a sustaining electrode, and a rear substrate formed with a plurality of address electrodes arranged orthogonal to the sustaining electrode pairs;
forming a dielectric layer over the sustaining electrode pairs of the rear substrate;
forming a plurality of barrier ribs on the lower dielectric layer, to define a first, second, and third discharge cells;
injecting a pigment comprising at least one of organic and inorganic materials exhibiting red into the first discharge cell, injecting a pigment comprising at least one of organic and inorganic materials exhibiting green into the second discharge cell, and injecting a pigment comprising at least one of organic and inorganic materials exhibiting blue into the third discharge cell;
drying the first, second, and third discharge cells filled with the pigments, to maintain the pigments in a state of being coated over side and upper surfaces of the barrier ribs facing in respective discharge cells;
forming a red phosphor layer in the first discharge cell; forming a green phosphor layer in the second discharge cell, and forming a blue phosphor layer in the third discharge cell;
baking and drying the red, green, and blue phosphor layers; and
assembling the front and rear substrates.

20. The method according to claim 19, wherein the injection of each pigment is carried out such that the pigment fills the associated discharge cell to cover the barrier ribs defining the associated discharge cells up to the upper surfaces of the barrier ribs.

21. The method according to claim 19, wherein:
the pigment injected into the first discharge cell comprises α-Fe₂O₃;
the pigment injected into the second discharge cell comprises at least one of (Co, Zn)O.(Al, Cr)₂O₃, 3CaO—Cr₂O₃.3SiO₂, and (Al, Cr)₂O₃; and
the pigment injected into the third discharge cell comprises at least one of CoOAl₂O₃, 2(Co, Zn)O.SiO₂, and ZrSiO₄.
